(19) United States
(12) Patent Application Publication
(10) Pub. No.: US 2011/0112773 A1
(43) Pub. Date: May 12, 2011

(54) MEASURING PROPERTIES OF STRATIFIED OR ANNULAR LIQUID FLOWS IN A GAS-LIQUID MIXTURE USING DIFFERENTIAL PRESSURE

(75) Inventor: Ian Atkinson, Cambridgeshire (GB)

(73) Assignee: Schlumberger Technology Corporation, Cambridge, MA (US)

(21) Appl. No.: 12/672,536

(22) PCT Filed: Sep. 17, 2008
(86) PCT No.: PCT/GB2008/003138

§ 371 Date: Jan. 19, 2011

Related U.S. Application Data
(60) Provisional application No. 60/973,373, filed on Sep. 18, 2007.

(51) Int. Cl. G01F 1/34; G01F 1/74; G01F 1/66

(52) U.S. Cl. 702/47; 73/861.04; 702/48

(57) ABSTRACT

Embodiments of the present invention provide for measuring flow properties of multiphase mixtures within a pipe carrying hydrocarbons. Embodiments of the present invention use differential pressure measurements of multiphase mixtures flowing in phase-separated flow regimes to analyze characteristics of a liquid phase of the multiphase mixture. The phase-separated flow regimes may be provided by flowing the multiphase mixture in a substantially horizontal pipeline or swirling the multiphase mixture. The combination of differential measurements with measurements from other sensors, such as ultrasonic sensors, microwave sensors, densitometers and/or the like may provide for multiphase flow measurements, such as flow rates of the different phases or determination of the speed of sound.

This application claims the benefit of and is a non-provisional of co-pending U.S. Provisional Application Ser. No. 60/973,373 filed on Sep. 18, 2007, which is hereby expressly incorporated by reference in its entirety for all purposes.

This application is related to U.S. application Ser. No. ______, filed on a date even herewith, entitled “MULTIPHASE FLOW MEASUREMENT” (temporarily referenced by Attorney Docket No. 57.0754 US NP), the disclosure of which is incorporated herein by reference for all purposes.

This application expressly incorporates by reference U.S. Pat. No. 6,758,100, filed on Jun. 4, 2001 and U.S. patent application Ser. No. 12/048,831, filed on Mar. 14, 2008; in their entirety for all purposes.

### BACKGROUND

This disclosure relates in general to multiphase flow measurement for oil-gas wells and, but not by way of limitation, to accurate measurement of various phases.

Most oil wells ultimately produce both oil and gas from the formation, and often produce water. Consequently, multiphase flow is common in oil wells. Surface monitoring of oil and gas producing wells is tending towards metering multiphase flows with a wide range of gas volume flow fraction (GVF).

There are existing approaches to metering multiphase flows which include separation and mixing approaches. The separation approach provides for splitting the flow into an almost liquid flow plus an almost gas flow flowing in separate conduits and then separately metering the separated flows using single-phase flow meters. The mixing approach attempts to minimize the slip between the different phases so that the velocity and holdup measurements can be simplified.

There are flow meters that measure flow rates in pipes that are intrusive into the flow. By intruding into the flow, the flow can be impeded and sensors can be fouled. Retrofitting pipes with a flow meter is problematic after it is operational. On occasion, the production of hydrocarbons is interrupted in this process.

Methods that are used to measure flow rate in a liquid phase of the multiphase flow make certain presumptions in analyzing the data to arrive at a flow rate. For example, a height of the gas-liquid interface or the speed of sound in the liquid phase might be estimated such that calculations can proceed. By not having accurate information on various parameters a certain amount of error is introduced to these flow rate determinations.

### SUMMARY

Embodiments of the present invention provide for measuring flow properties of multiphase mixtures within a pipe carrying hydrocarbons. Embodiments of the present invention use differential pressure measurements of multiphase mixtures flowing in phase-separated flow regimes to analyze characteristics of a liquid phase of the multiphase mixture. The phase-separated flow regimes may be provided by flowing the multiphase mixture in a substantially horizontal pipeline or swirling the multiphase mixture. The combination of differential measurements with measurements from other sensors, such as ultrasonic sensors, microwave sensors, densitometers and/or the like may provide for multiphase flow measurements, such as flow rates of the different phases or determination of the speed of sound.

In one embodiment, the present disclosure provides a method for measuring flow properties of a multiphase mixture flowing in a pipe of stratified flow. The method includes flowing the multiphase mixture through the pipe in a phase separated flow regime, wherein the phase separated flow regime separates a liquid phase of the multiphase mixture and a gas phase of the multiphase mixture; measuring a differential pressure across a diameter of the pipe; and using a density of the gas phase, a density of the liquid phase and the measured differential pressure to determine a liquid layer thickness of the liquid phase of the multiphase mixture flowing in the pipe.

In another embodiment, the present disclosure provides a system for measuring flow properties of a multiphase mixture flowing in a pipe of stratified flow. The system includes an ultrasonic transducer, a differential pressure sensor and a processor. The ultrasonic transducer is configure to operatively engage the pipe without intruding into the stratified flow and measure velocity in the pipe. The differential pressure sensor is configured to operatively engage with the pipe at two points and measure flow a difference in pressure between the two points. The processor is configured to determine a height of a gas-liquid interface within the pipe using the differential pressure and calculate liquid flow within the pipe using the velocity and the height.

In yet another embodiment, the present disclosure provides a method for measuring flow properties of a multiphase mixture including hydrocarbons flowing in a pipe of stratified flow is disclosed. In one step, a differential pressure between two points of the pipe is sampled. A height of a gas-liquid interface within the pipe is determined using the differential pressure. A gas velocity and/or a liquid velocity of the stratified flow is measured without intruding into the stratified flow. A liquid flow within the pipe is calculated using the gas velocity and/or the liquid velocity and the height.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A and 1B depict block diagrams of embodiments of a multiphase flow measurement system;

FIGS. 2A and 2B depict orthographic diagrams of embodiments of a pipe configuration detailing components of the multiphase flow measurement system;

FIGS. 3A and 3B depict cross-sectional plan views of embodiments of the pipe configuration where the cross-section is in a vertical plane generally aligned with flow within the pipeline;

FIGS. 4A-4D depict cross-sectional plan views of embodiments of the pipe configuration where the cross-section is in a plane generally parallel to a gas-liquid interface; and

FIG. 5 illustrates a flowchart of an embodiment of a process for measuring properties of multiphase flow of hydrocarbons within a pipeline.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It being understood that various changes may be made in the function and arrangement of elements without departing from the spirit and scope as set forth in the appended claims.

Multi-phase flow is commonly produced during hydrocarbon production. The liquid phase can include hydrocarbons, water and/or various contaminants. Some methods rely on one or more ultrasonic transducers that transmit pulses into the liquid phase to determine a height of a gas-liquid interface based upon time-of-flight measurements. Doppler can be used be used to determine the direction and velocity of flow. These measurements use a value for the speed of sound, but some methods estimate a typical value for the speed of sound even though it varies with the make-up of the liquid phase.

In one aspect, pressure sensing is used to find a difference in pressure within the pipeline. The pressure is affected by the make-up of the multiphase flow. The difference in pressure between the bottom and top of the pipeline is used in determining a height of the gas-liquid interface. Essentially, the pressure differential allows weighing the multi-phase flow. Presuming or measuring densities for the gas and liquid flows allows for estimation of the height of the gas-liquid interface.

As described in this application, measurement of flow properties of multiphase mixtures has been of significant importance, especially in the hydrocarbon industries for many years. In this time, many methods and systems have been developed for and considerable time and expense has been put into to development of measuring the flow properties of the phases of a multiphase mixture. In this application, methods and systems are described in which the flow regime of the multiphase mixture flow is controlled, by developing a horizontal stratified flow or developing a swirling stratified flow in a pipe and using a differential pressure sensor to interrogate the flow and, among other things, determine flow properties of the liquid phase, such as liquid phase thickness. This surprising development may lead to the manufacture of lower cost and/or more accurate multiphase flow meters.

In one embodiment of the present invention, the ultrasonic pulsed Doppler transducers are arranged in a Doppler array around the circumference of the pipeline to measure the gas-liquid flow. Additionally, the Doppler array can be used to estimate the water/liquid hydrocarbon ratio (WLR) measurement in some embodiments.

The slip velocity between the liquid and gas phases for a horizontal flow is very different from that for a vertical flow with the same gas volume flow fraction (GVF) value. Normally, the slip in the horizontal case is much larger. This means that even with the same GVF, the liquid holdup in the horizontal case is normally much larger than that in the vertical case. As a result, the flow regime map for horizontal flows is very different from that for vertical flows.

Applicants have determined that liquid holdup is typically 15 times of liquid cut for GVF>0.95 and the liquid flow rate<3 m³/hr. This means that if the liquid flow rate is 1% of the total flow rate, then the liquid holdup is 15%. Therefore, the gravity separation helps to create a liquid-rich region towards the lower part of a horizontal pipe, and a gas-rich region above it. Knowing the phase distribution in such flows, Applicants submit that various velocity and holdup measurements may be optimized for the different phase regions.

Gas velocity may be measured by using a gas flowmeter, e.g. an ultrasonic gas flowmeter, which may be installed around the appropriate height of the pipe bore to ensure measurement of the gas-only/gas-rich zone. The liquid flow velocity and liquid holdup may be measured by an array of ultrasonic Doppler transducers mounted around the circumference of the pipe. The WLR in the liquid-phase may be further characterized using at least one pair of electromagnetic microwave transmitter and receiver, whose transmission path is mostly covered by the liquid-rich region towards the bottom of the pipe. The flowmeter may be built around a section of straight pipeline and may use non-intrusive sensors, and, therefore, provide no disturbance to the flow.

In one embodiment of the present invention, an ultrasonic clamp-on transit-time gas flowmeter and a range-gated ultrasonic Doppler transducer may be used for the measurement of gas and liquid flow velocities of stratified gas-liquid flow in a horizontal or near horizontal production pipeline. The ultrasonic Doppler transducer may be installed at the pipe underside to measure the flow velocity and thickness (hence volume fraction) of the dominant liquid layer. The liquid-layer thickness may be estimated from a time delay measurement where the range-gated Doppler energy is at a maximum. The gas and liquid flow rates may then be determined from the above gas-liquid velocities and liquid fraction measurements, without intruding into the production flows within the pipeline.

In certain aspects, transit-time (gas) and Doppler (liquid) flow velocity and holdup measurements may also be used to derive the prevalent flow-regime information (from flow-regime maps), hence facilitating the use of a more flow-regime specific correlation of gas-liquid velocity slip for an alternative determination of gas-liquid flow rates. An estimation of the speed of sound in the liquid phase allows the ultrasonic measurements to be more accurate.

In stratified flow regimes, a clamp-on ultrasonic gas flow meter may be used with a pulsed Doppler sensor(s) and/or a microwave EM sensor(s) to measure flow characteristics of a multiphase (gas-liquid) mixture flowing in a pipeline. For such measurements to be accurate and robust, it may be desirable to measure a thickness of the liquid portion of the stratified flow of the gas-liquid as accurately as possible. As such, embodiments of the present invention provide for an independent measure of the liquid layer thickness using a differential pressure measurement that can be used in combination with other ultrasonic measurements. Embodiments of the present invention may be used for flow regimes that are either stratified, such as may be found in near horizontal flows and/or a flow regime comprising a liquid annulus and gas core, such as may be created by inducing a swirling-type of flow in the gas-liquid.

Ultrasonic measurements of flowing liquid layers with velocity, v and thickness h, give for an ultrasonic beam perpendicular to the flow direction:

$$t = \frac{2 h}{{c}_{liquid}} ,$$

where t=measured delay time, c_{liquid}=liquid sound velocity
Doppler: v(depth=T*c_{liquid})∝ Doppler frequency shift*C_{liquid} where T=gate time
Time of flight: v=v(c_{liquid,}h,t)

Combinations of ultrasonic measurements can give the liquid film velocity, liquid sound velocity and liquid layer thickness. However the interdependency of these parameters makes accurate measurements difficult when presumptions are used as input to the above equations; for example, the speed of sound in the liquid layer. This invention describes an independent measure of the liquid layer thickness using a differential pressure measurement that can be used in combination with various ultrasonic measures. The flow regime is either stratified or a liquid annulus and gas core created by swirling the fluid.

The concept comprises measuring the differential pressure across the diameter of a horizontal pipe in which there is stratified gas-liquid flow or a liquid annulus and gas core induced by swirling the flow. A priori measurements or estimations of the gas and liquid densities allows determination of the liquid layer thickness. Some embodiments could measure the density of the gas and liquid phases with a sensor or make periodic measurements.

An advantage of measuring the differential pressure perpendicular to the flow velocity, as provided in some embodiments of the present invention, is that there is little or no frictional pressure drop to be taken into account in this embodiment.

The differential pressure, ΔP, measured across the diameter, D, of a horizontal pipe is:

### Stratified Flow:

ΔP=g(h(ρ_{liquid}−ρ_{gas})+Dρ_{gas})

### Annular Flow:

ΔP=g(2h(ρ_{liquid}−ρ_{gas})+Dρ_{gas})

The diameter can be measured or may be known for standard pipe sizes. Some embodiments could use the ultrasonic transducer(s) to automatically determine the diameter.

Given the liquid and gas densities, the liquid layer thickness can be determined from the above equations. Merely by way of example, densities of the gas and liquid phases may be automatically determined from radiation count measurements, Venturi type measurements, microwave measurements and/or the like in various embodiments.

If the water-liquid ratio is not known, then an estimate of the liquid density may be provided when WLR=0.5. Other embodiments could use a determined value for the WLR using EM microwave devices, for example.

The uncertainty in the thickness measurement for an uncertainty in the differential pressure measurement is:

$$δ h = \frac{δ Δ P}{2 g ( {ρ}_{liquid} - {ρ}_{gas} )}$$

At 10 mbar span the Honeywell STD110 differential pressure sensor has an accuracy of ±0.01 mbar; this results in an accuracy of ˜0.07 mm for h if used for these types of measurements. Other embodiments could use other differential pressure sensors.

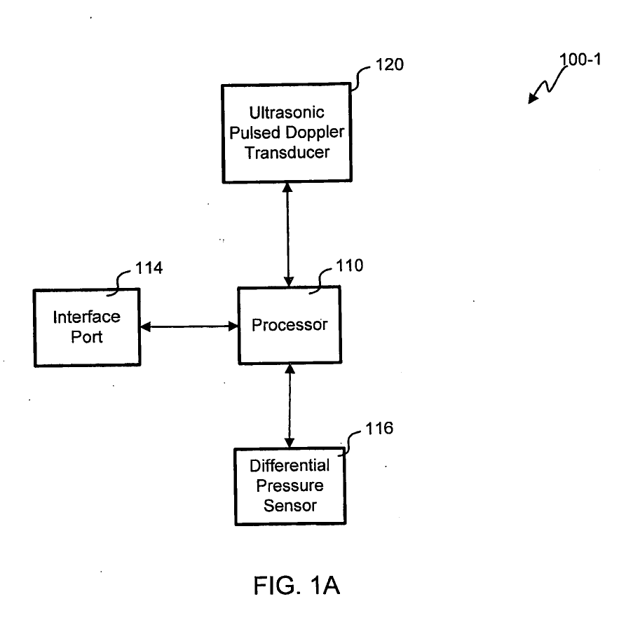

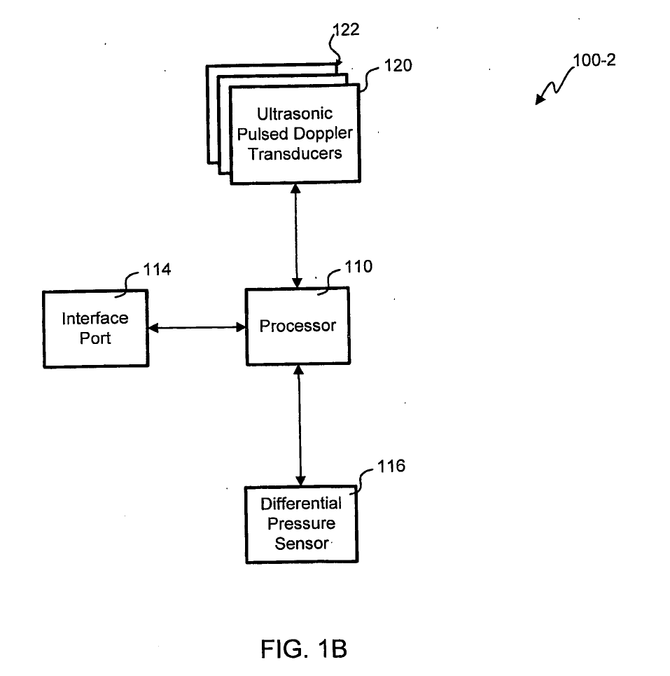

Referring first to FIG. 1A, a block diagram of an embodiment of a multiphase flow measurement system 100-1 is shown. The multiphase flow measurement system 100 measures flow of the liquid phase. Among other places in this specification, this embodiment is variously described in at least FIGS. 1A, 2A, 4A and 4C. This embodiment includes an ultrasonic pulsed Doppler transducer 120, a differential pressure sensor 116, a processor 110, and an interface port 114. Once installed, the analysis of the flow can be done automatically without intrusion into the flow within the pipeline.

The ultrasonic pulsed Doppler transducer 120 is range-gated in this embodiment. The Doppler transducer 120 could operate at 1 MHz, for example, to measure flow velocity of the dominant liquid layer. This embodiment clamps the ultrasonic pulsed Doppler transducer 120 on the pipe underside to measure the flow velocity of the dominant liquid layer flowing at the pipe bottom. Additionally, the liquid level or height of the liquid-gas interface can also be determined by the ultrasonic pulsed Doppler transducer 120. The internal cross-sectional area of the pipe can be measured from an ultrasonic pipe-wall thickness gauge, or estimated with readings from the ultrasonic pulsed Doppler transducer 120. The internal cross-sectional area is used with the flow rate measurement to determine the volume of liquid, hydrocarbon and/or gas passing through the pipeline.

The differential pressure sensor 116 attaches to the pipe at two points to measure the difference in pressure between those two points. In this embodiment, one end of the pressure sensor is coupled to the bottom of the horizontally configured pipeline and the other sensor is coupled to the top of the pipeline. The difference in pressure generally corresponds to the weight of the contents within the pipeline. Presuming or measuring densities of the phases, the height of the liquid-gas interface can be determined. Other embodiments could use several pairs of pressure measurements differentially to gather more data points for pressure difference in the pipeline.

A processor 110 is configured with a state machine and/or software to automatically determine certain parameters from the gathered information. Additionally, the various sensors and transducers are driven and read with the processor 110. Gas, liquid and hydrocarbon flow and volume can be determined by the processor 110. Any input or output of the multiphase flow measurement system 100 passes through an interface port 114. Some embodiments could include a display that shows the determined results and measurements, but this embodiment just relays that information out the interface port 114 to a data logging device.

With reference to FIG. 1B, a block diagram of another embodiment of the multiphase flow measurement system 100-2 is shown. Among other places in this specification, this embodiment is variously described in at least FIGS. 1B, 2B, 4B and 4D. This embodiment uses multiple ultrasonic pulsed Doppler transducers 120 arranged into a Doppler array 122 to allow more accurate readings than when a single transducer 120 is used as in the embodiment of FIG. 1A. The spatial distribution of the transducers 120 in the Doppler array 122 in some aspects of the present invention may be dense around the lower part of the horizontal pipe to provide better liquid-gas interface detection resolution.

When there is only a film of liquid within the pipe adjacent to a Doppler transducer 120 the reflection is considerably different from the circumstance were the Doppler transducer 120 is adjacent to the liquid phase. The returned Doppler energy level is higher when the Doppler transducer 120 is adjacent to the liquid phase. By noting which Doppler transducers 120 appear to be adjacent to a film rather than the liquid phase, the liquid-gas interface can be further estimated in this embodiment. Further, other ultrasonic transducer readings can be improved by using the Doppler array 122.

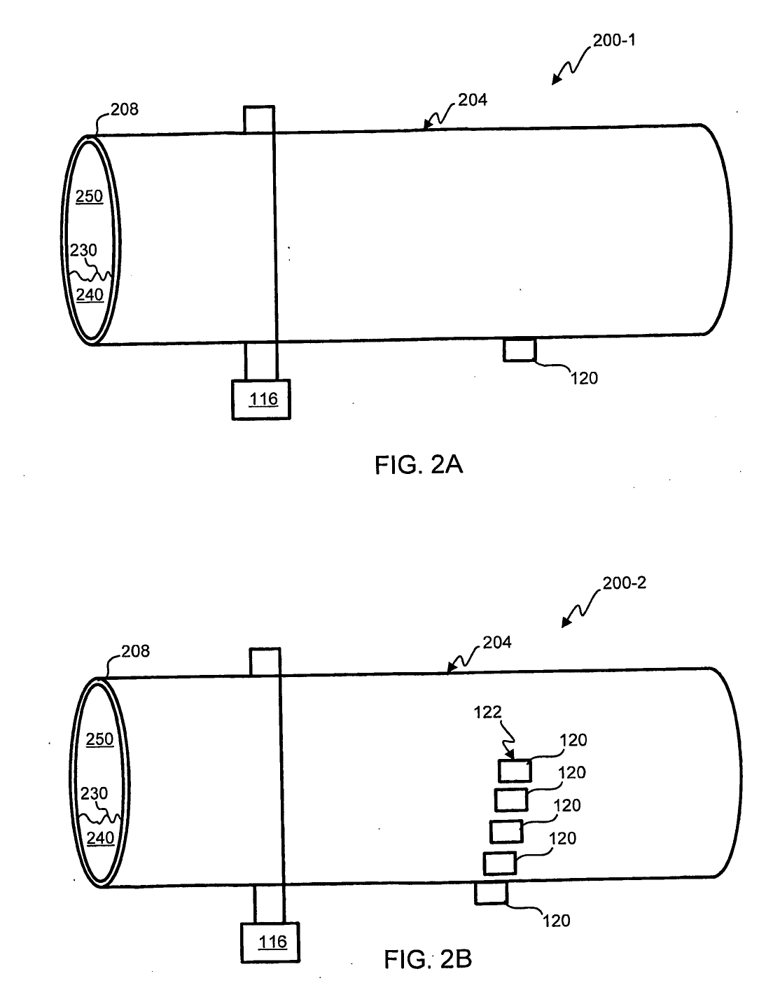

With reference to FIG. 2A, an orthographic diagram of an embodiment of a pipe configuration 200-1 is shown that details components of the multiphase flow measurement system 100-1. The pipeline 204 is made from a plastic liner 208 arranged in a cylindrical form. Within the pipeline are a liquid phase 240 and a gas phase 250 separated by a liquid-gas interface. This embodiment uses a single ultrasonic pulsed Doppler transducer 120 located at a bottom of the pipeline 204. The differential pressure sensor 116 is coupled across the pipeline 204 from top to bottom.

Referring next to FIG. 2B, an orthographic diagram of another embodiment of a pipe configuration 200-2 is shown that details components of the multiphase flow measurement system 100-2. This embodiment has multiple ultrasonic pulsed Doppler transducers 120 arranged circumferentially on a front of the pipeline 204. Additional ultrasonic pulsed Doppler transducers 120 allow for more accurate readings. Further, the height of the liquid-gas interface can be determined with generally better accuracy when there is a Doppler array 122 arranged about a circumference of the pipeline 204. Although this embodiment arranges the Doppler array 122 on one side of the pipeline 204, other embodiments could arrange the Doppler array 122 circumferentially generally traversing the bottom hemisphere of the pipeline 204.

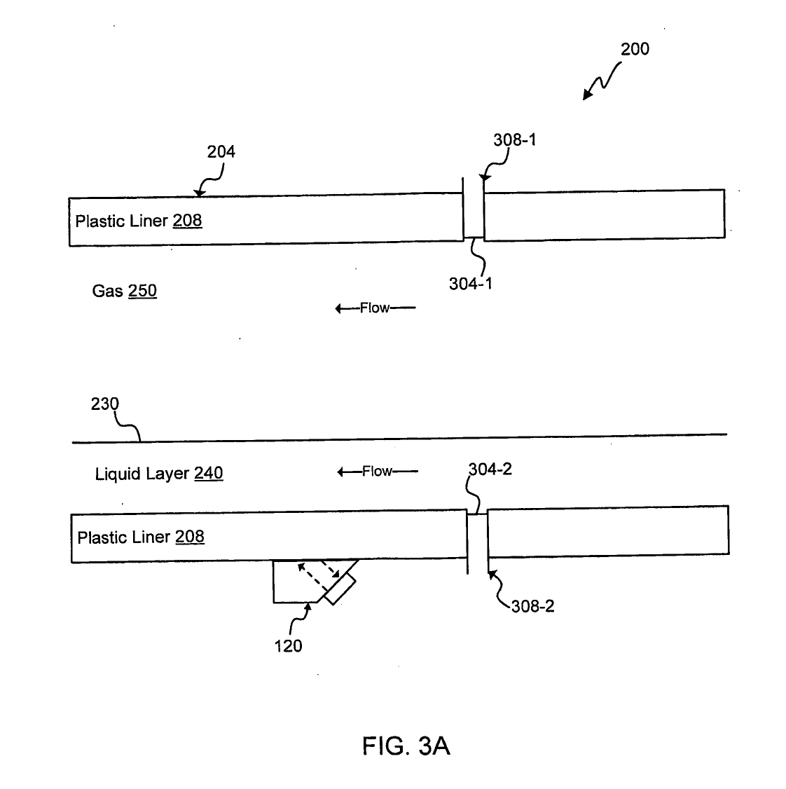

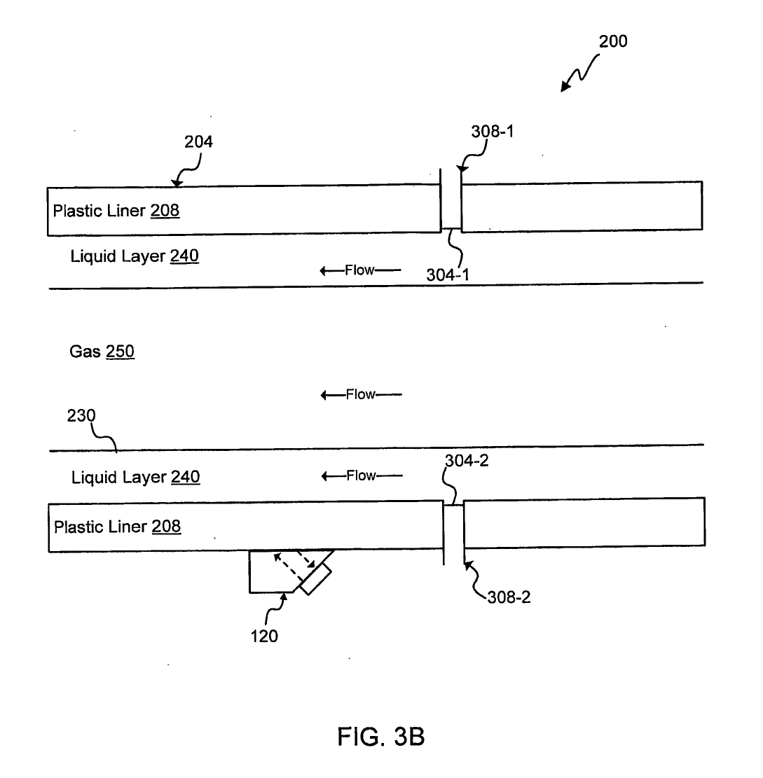

With reference to FIG. 3A, a cross-sectional plan view of an embodiment of the pipe configuration 200 is shown where the cross-section is in a vertical plane generally aligned with flow within the pipeline 204. In this embodiment, the multiphase flow is horizontally stratified with the liquid layer 240 at the bottom of the pipeline 204 and the gas phase at the top of the pipeline 204. At the bottom of the plastic liner 208 is a detailed depiction of a ultrasonic pulsed Doppler transducer 120.

A top chamber 308-1 and a bottom chamber 308-2 are each pressure coupled to the interior of the pipeline 204. The chambers 308 are aligned on a vertical diameter to engage the pipeline 204 near the top and bottom. By attaching a tube to each chamber 308 the pressure can be coupled to the differential pressure sensor 116. Each chamber 308 is separated from the contents of the pipeline with a diaphragm 304 suitable as a barrier to keep contamination out of the chamber 308. The chamber and accompanying tube may be filled with an inert gas or a isolation fluid.

Although not shown, some embodiments can increase or decrease an inner diameter of the pipeline 204. Decreasing the inner diameter increases the flow rate, and increasing the inner diameter decreases the flow rate. Various embodiments can add a section with an increased or decreased diameter near the chambers 308.

Referring next to FIG. 3B, a cross-sectional plan view of an embodiment of the pipe configuration 200 is shown where the cross-section is in a vertical plane generally aligned with flow within the pipeline 204. In this embodiment, the liquid phase is distributed annularly proximate to the interior wall of the pipeline 204. A swirling device can be used to distribute the liquid phase 240 annularly.

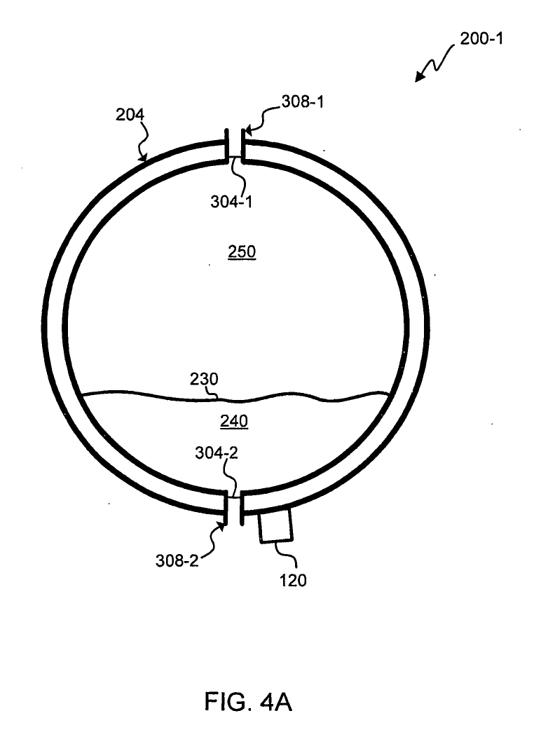

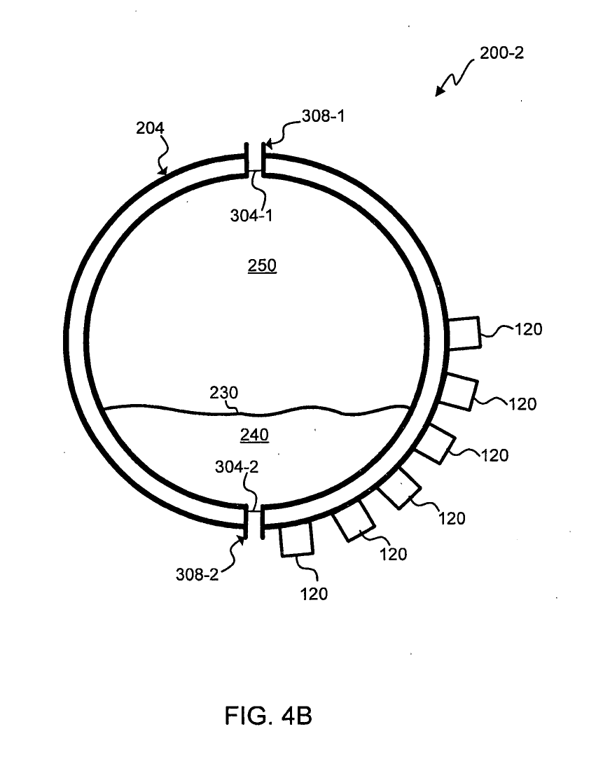

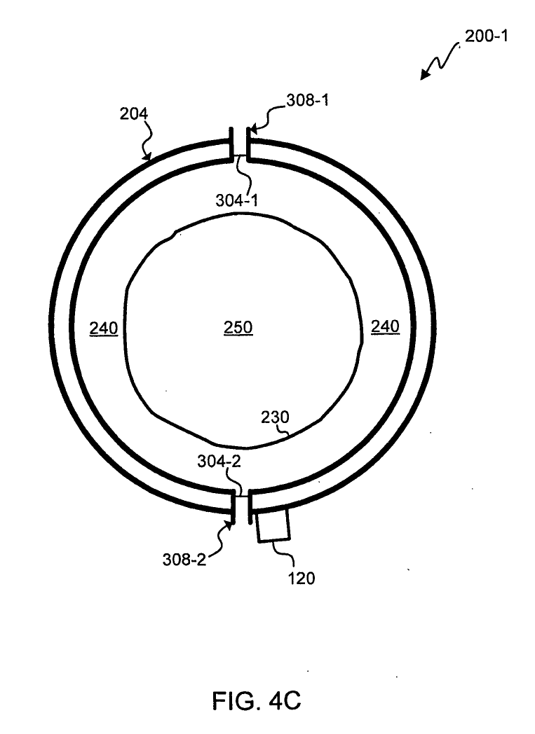

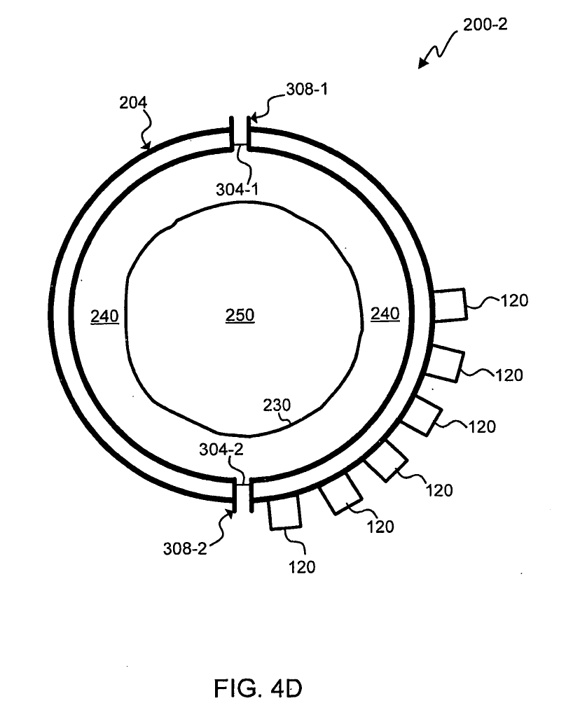

With reference to FIG. 4A, a cross-sectional plan view of an embodiment of the pipe configuration 200-1 is shown where the cross-section is in a plane generally perpendicular to flow within the pipe 204. Only some of the multiphase flow measurement system 100-1 is shown in this view. The ultrasonic pulsed Doppler transducer 120 is shown at the bottom of the pipeline 204 to measure the flow of the liquid phase 240 among other things. The chambers 308 that are pressure coupled to the interior of the pipeline 204 is also shown. Each chamber 308 has a diaphragm 304 to prevent fouling of the tubes coupling the chambers to the differential pressure sensor 116.

Referring next to FIG. 4B, a cross-sectional plan view of another embodiment of the pipe configuration 200-2 is shown where the cross-section is in a plane generally perpendicular to flow within the pipe 204. This view shows the Doppler array 122 of the multiphase flow measurement system 100-2. Six ultrasonic pulsed Doppler transducers 120 are used in this embodiment. The fifth and sixth ultrasonic pulsed Doppler transducers 120 are above the gas-liquid interface 230 and the fourth ultrasonic pulsed Doppler transducers 120-4 is below. By analysis of the readings from these transducers 120, the processor can determine that the gas-liquid interface 230 is between the fourth and fifth transducers. Further, other transducers below the gas-liquid interface 230 can estimate the height using reflections from the pulses. The differential pressure sensor 116 can also be used to estimate the height of the gas-liquid interface 230.

With reference to FIG. 4C, a cross-sectional plan view of still another embodiment of the pipe configuration 200-1 is shown where the cross-section is in a plane generally perpendicular to flow within the pipe 204. The multiphase flow in this embodiment is annular. Differential pressure sensing and a single pulsed Doppler transducer 120 are used in this embodiment to analyze the multiphase flow. A swirling device is inserted into the pipeline to create the annular flow.

Referring next to FIG. 4D, a cross-sectional plan view of yet another embodiment of the pipe configuration 200-2 is shown where the cross-section is in a plane generally perpendicular to flow within the pipe 204. Like the embodiment of FIG. 4C, this embodiment uses an annular flow. This embodiment uses a Doppler array 122 along with the differential pressure sensor 116 to analyze the multiphase flow.

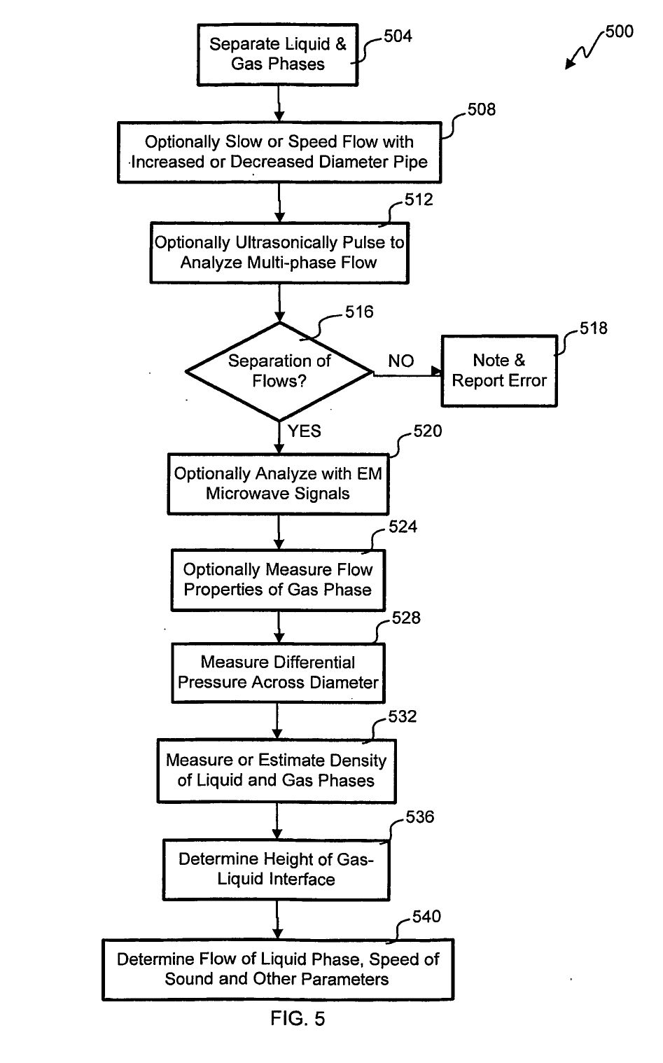

With reference to FIG. 5, a flowchart of an embodiment of a process 500 for measuring properties of multiphase flow of hydrocarbons within a pipeline 204 is shown. The depicted portion of the process begins in block 504 where the liquid and gas phases 240, 250 are stratified. A horizontal section of pipe 204 can be used to stratify, or a mixing element can be introduced to swirl the flow annularly. The speed of the flow can be optionally increased or decreased by adding a section with a larger or smaller diameter in block 508.

The ultrasonic pulsed Doppler transducer(s) 120 can optionally measure the flow of the liquid phase 240 in block 512. Additionally, the ultrasonic pulsed Doppler transducer(s) 120 can optionally measure the height of the gas-liquid interface 230 using reflections, the estimated speed of sound and/or by noticing which transducers 120 in a Doppler array 122 appear to not be submerged. Additionally, the WLR can be optionally determined by an analysis of readings from the ultrasonic pulsed Doppler transducer(s) 120.

The Doppler transducer(s) 120 allow confirmation of stratified flow in block 516. Where a separated flow regime cannot be confirmed, processing goes to block 518 where the error is noted and reported. Other measurements may be taken where there is not a separated flow regime. Where separated flows are determined in block 516, processing goes to block 520.

EM microwave elements could be optionally used in block 520 for an estimate of WLR. In block 524, a gas flowmeter can optionally measure the velocity of the gas phase 250. In step 528, the differential pressure between the chambers 308 is measured by the differential pressure sensor 116. The density of the gas and/or liquid phases can be measured with dosimeters in block 532. Other embodiments could use experimentation, prior knowledge and modeling to find densities of the gas and liquid phases.

The processor 110 in block 536 determines the height of the gas-liquid interface 230 using the differential pressure, the density of the gas layer, and/or the density of the liquid layer. In block 540, the flow rate, speed of sound in the liquid phase and other parameters can be further determined. Determined information may be relayed to other systems through the interface port 114 and/or displayed.

A number of variations and modifications of the disclosed embodiments can also be used. For example, the various flowmeters, arrays, transducers, sensors, transmitters, and receivers can be combined in various ways for a given multiphase flow measurement system. Additionally, the number of sensors, probes and transducers can be different in various embodiments. For example, several differential pressure sensors could be used to more accurately weigh the flow. Above embodiments are discussed in the context of hydrocarbon transport, but the invention need not be limited to hydrocarbons.

While the principles of the disclosure have been described above in connection with specific apparatuses and methods, it is to be clearly understood that this description is made only by way of example and not as limitation on the scope of the disclosure.

What is claimed is:

1. A method for determining flow properties of a multiphase mixture, the method comprising steps of:
flowing the multiphase mixture through a section of pipe in a phase separated flow regime, wherein the phase separated flow regime comprises a flow of the multiphase mixture in which a liquid phase of the multiphase mixture and a gas phase of the multiphase mixture are separated;
measuring a differential pressure across a diameter of the section of pipe; and
using a density of the gas phase, a density of the liquid phase and the measured differential pressure to determine a liquid layer thickness of the liquid phase of the multiphase mixture flowing in the section of pipe.

2. The method for determining the flow properties of a multiphase mixture as recited in claim 1, wherein the phase separated flow regime is a stratified flow.

3. The method for determining the flow properties of a multiphase mixture as recited in claim 2, further comprising a step of generating the stratified flow by providing that the section of pipe is substantially horizontal.

4. The method for determining the flow properties of a multiphase mixture as recited in claim 2, further comprising the step of:
generating the stratified flow by providing that the section of pipe is substantially horizontal and reducing a flow rate of the multiphase mixture in the horizontal section of pipe.

5. The method for determining the flow properties of a multiphase mixture as recited in claim 4, wherein flow rate is reduced in the horizontal section of pipe by flowing the multiphase mixture through at least a portion of the section of pipe having an expanded internal diameter.

6. The method for determining the flow properties of a multiphase mixture as recited in claim 3, wherein the measuring step comprises a step of measuring differential pressure across a vertical diameter of the horizontal pipe section.

7. The method for determining the flow properties of a multiphase mixture as recited in claim 1, wherein the phase separated flow regime is an annular flow.

8. The method for determining the flow properties of a multiphase mixture as recited in claim 6, further comprising a step of generating the annular flow by swirling the multiphase mixture.

9. The method for determining the flow properties of a multiphase mixture as recited in claim 8, further comprising a step of passing the multiphase mixture through a constriction in the pipe.

10. The method for determining the flow properties of a multiphase mixture as recited in claim 1, further comprising a step of using one or more ultrasonic transducers to determine when the multiphase mixture is flowing through the pipe in the phase separated flow regime.

11. The method for determining the flow properties of a multiphase mixture as recited in claim 10, further comprising a step of determining that the differential pressure measurements are valid when the phase separated flow regime is determined.

12. The method for determining the flow properties of a multiphase mixture as recited in claim 1, wherein the densities of the liquid phase and the gas phase are determined from one of measurement, experimentation, prior knowledge, and modeling.

13. The method for determining the flow properties of a multiphase mixture as recited in claim 1, further comprising a step of measuring a velocity of the liquid phase and using the velocity and the liquid layer thickness to process a flow rate of the liquid phase.

14. The method for determining the flow properties of a multiphase mixture as recited in claim 1, further comprising a step of measuring a velocity of the gas phase and using the velocity and the liquid layer thickness to process a flow rate of the gas phase.

15. The method for determining the flow properties of a multiphase mixture as recited in claim 1, further comprising steps of:
emitting an ultrasonic beam into the pipe;
receiving at a detection location a reflected ultrasonic beam, wherein the reflected ultrasonic beam is a reflection of the emitted ultrasonic beam from an interface between the liquid phase of the multiphase mixture and the gas phase of the multiphase mixture;
measuring a time of flight for the ultrasonic beam to travel to the interface and back to the detection location; and
processing a speed of sound from the liquid layer thickness and the time of flight, wherein the speed of sound is a speed of sound in the liquid phase of the multiphase mixture.

16. A system for determining flow properties of a multiphase mixture, the system comprising:
a substantially horizontal section of pipe;
a differential pressure sensor coupled with the horizontal section of pipe and configured to measure a differential pressure across a vertical diameter of the horizontal pipe, wherein the differential pressure sensor is disposed at position on the horizontal section of pipe where the multiphase mixture is flowing as a stratified flow; and
a processor configured to receive an output from differential pressure sensor and to process a liquid layer thickness of a liquid phase of the multiphase mixture flowing in the horizontal section of pipe from the output and a density of a gas phase of the multiphase mixture and a density of the liquid phase.

17. The system for determining flow properties of a multiphase mixture as recited in claim 16, further comprising:
one or more ultrasonic transducers coupled with the horizontal section of pipe and configured to determine whether the flow of the multiphase mixture is stratified.

18. The system for determining flow properties of a multiphase mixture as recited in claim 16, further comprising:
an ultrasonic emitter coupled with the horizontal section of pipe and configured to emit an ultrasonic signal into the multiphase mixture; and
an ultrasonic receiver coupled with the horizontal section of pipe configured to receive a reflection of the emitted ultrasonic signal from an interface between the gas phase and the liquid phase and to provide a time of flight output corresponding to the time of flight of the reflected signal to the processor, wherein the processor calculates a velocity of a speed of sound in the liquid phase from the time of flight output and the liquid layer thickness.

19. A system for determining flow properties of a multiphase mixture flowing in a pipe, the system comprising:
a swirl generator coupled with the pipe and configured to cause the multiphase mixture to undergo a swirling flow through the pipe;
a differential pressure sensor coupled with the pipe and configured to measure a differential pressure across a diameter of the pipe; and
a processor configured to receive an output from differential pressure sensor and to process a liquid layer thickness of a liquid phase of the multiphase mixture flowing in the horizontal section of pipe from the output and a density of a gas phase of the multiphase mixture and a density of the liquid phase.

20. The system for determining flow properties of a multiphase mixture as recited in claim 19, further comprising:
one or more ultrasonic transducers coupled with the pipe and configured to determine whether the flow of the multiphase mixture is annular.

21. The system for determining flow properties of a multiphase mixture as recited in claim 19, further comprising:
an ultrasonic emitter coupled with the pipe and configured to emit an ultrasonic signal into the multiphase mixture; and
an ultrasonic receiver coupled with the pipe configured to receive a reflection of the emitted ultrasonic signal from an interface between the gas phase and the liquid phase and to provide a time of flight output corresponding to the time of flight of the reflected signal to the processor, wherein the processor calculates a velocity of a speed of sound in the liquid phase from the time of flight output and the liquid layer thickness.

22. A system for measuring flow properties of a multiphase mixture in a pipe, the system comprising:
a differential pressure sensor:
configured to operatively engage with the pipe at two points across a diameter of the pipe wherein:
the pipe which is configured to transport the multiphase mixture that flows through the pipe in a phase separated flow regime, and
the phase separated flow regime separates a liquid phase of the multiphase mixture and a gas phase of the multiphase mixture, and
configured to measure a difference in pressure between the two points; and
a processor configured to determine a liquid layer thickness of the liquid phase of the multiphase mixture flowing in the pipe using a density of the gas phase, a density of the liquid phase and the difference in pressure.

23. The system for measuring flow properties of the multiphase mixture in the pipe as recited in claim 22, wherein the phase separated flow regime is a stratified flow.

24. The system for measuring flow properties of the multiphase mixture in the pipe as recited in claim 23, wherein the stratified flow is generated by flowing the multiphase mixture through a horizontal section of the pipe.

25. The system for measuring flow properties of the multiphase mixture in the pipe as recited in claim 23, wherein:
the stratified flow is generated by flowing the multiphase mixture through a horizontal section of the pipe, and
the horizontal section of the pipe includes a section with an expanded internal diameter to provide for reducing a flow rate of the multiphase mixture.

26. The method for determining the flow properties of a multiphase mixture flowing in the pipe as recited in claim 24, wherein the two points are across a vertical diameter of the horizontal pipe section.

27. The system for measuring flow properties of the multiphase mixture in the pipe as recited in claim 22, wherein the phase separated flow regime is an annular flow.

28. The method for determining the flow properties of a multiphase mixture flowing in the pipe as recited in claim 23, wherein the stratified flow is generated by swirling the multiphase mixture.

29. The method for determining the flow properties of a multiphase mixture flowing in the pipe as recited in claim 28, wherein the swirling the multiphase mixture is passed through a constriction in the pipe.

30. The system for measuring flow properties of the multiphase mixture in the pipe as recited in claim 22, further comprising a step of using an ultrasonic transducer to determine when the multiphase mixture is flowing through the pipe in the phase separated flow regime.

31. The system for measuring flow properties of the multiphase mixture in the pipe as recited in claim 30, wherein the processor does not use the differential pressure measurements when the processor determines that the multiphase mixture is not flowing in the phase separated flow regime.

32. The system for measuring flow properties of the multiphase mixture in the pipe as recited in claim 22, wherein the densities of the liquid phase and the gas phase are determined from one of measurement, experimentation, prior knowledge, and modeling.

33. The system for measuring flow properties of the multiphase mixture in the pipe as recited in claim 22, wherein a velocity of the liquid phase is measured and the velocity and the liquid layer thickness are used to determine a flow rate of the liquid phase.

34. The system for measuring flow properties of the multiphase mixture in the pipe as recited in claim 22, wherein a velocity of the gas phase is measured and the velocity and the liquid layer thickness are used to determine a flow rate of the gas phase.

35. The system for measuring flow properties of the multiphase mixture in the pipe as recited in claim 22, further comprising an ultrasonic transducer configured to:
emit an ultrasonic beam into the pipe;
receive at a detection location a reflected ultrasonic beam, wherein the reflected ultrasonic beam is a reflection of the emitted ultrasonic beam from an interface between the liquid phase of the multiphase mixture and the gas phase of the multiphase mixture;
measure a time of flight for the ultrasonic beam to travel to the interface and back to the detection location; and
process a speed of sound from the liquid layer thickness and the time of flight, wherein the speed of sound is a speed of sound in the liquid phase of the multiphase mixture.

36. A system for measuring flow properties of a multiphase mixture flowing in a pipe of stratified flow, the system comprising:
an ultrasonic transducer:
configured to operatively engage the pipe without intruding into the stratified flow, and
configured to measure velocity in the pipe;
a differential pressure sensor:
configured to operatively engage with the pipe at two points, and
configured to measure flow a difference in pressure between the two points; and
a processor configured to:
determine a height of a gas-liquid interface within the pipe using the differential pressure, and
calculate liquid flow within the pipe using the velocity and the height.

37. The system for measuring flow properties of the multiphase mixture flowing in the pipe of stratified flow as recited in claim 36, wherein the processor is further configured to determine speed of sound in a liquid phase within the pipe.

38. The system for measuring flow properties of the multiphase mixture flowing in the pipe of stratified flow as recited in claim 36, further comprising a swirling mechanism that distributes the liquid phase in an annulus.

39. The system for measuring flow properties of the multiphase mixture flowing in the pipe of stratified flow as recited in claim 36, wherein the pipe is arranged horizontally to stratify the multiphase mixture.

40. The system for measuring flow properties of the multiphase mixture flowing in the pipe of stratified flow as recited in claim 36, wherein:
the pipe is arranged horizontally to stratify the multiphase mixture,
the ultrasonic transducer is a pulsed Doppler transducer, and
the pulsed Doppler transducer operatively engages a lower half of the pipe below a horizontal plane aligned with the middle line of the pipe.

41. The system for measuring flow properties of the multiphase mixture flowing in the pipe of stratified flow as recited in claim 36, wherein the ultrasonic transducer is one of a plurality of pulsed Doppler transducers arranged in a Doppler array.

42. The system for measuring flow properties of the multiphase mixture flowing in the pipe of stratified flow as recited in claim 36, wherein the ultrasonic transducer is a range-gated Doppler transducer.

43. The system for measuring flow properties of the multiphase mixture flowing in the pipe of stratified flow as recited in claim 36, wherein the height is used with a time of flight measurement by the ultrasonic transducer to determine a speed of sound in a liquid phase within the pipe.

44. A method for measuring flow properties of a multiphase mixture including hydrocarbons flowing in a pipe of stratified flow, the method comprising steps of:
sampling a differential pressure between two points of the pipe;
determining a height of a gas-liquid interface within the pipe using the differential pressure;
measuring a gas velocity and/or a liquid velocity of the stratified flow without intruding into the stratified flow; and
calculating liquid flow within the pipe using the gas velocity and/or the liquid velocity and the height.

45. The method for measuring flow properties of the multiphase mixture including hydrocarbons flowing in the pipe of stratified flow as recited in claim 44, wherein:
the two points include a first point and a second point, and
the first point is generally opposite from the second point and generally arranged along a circumference of the pipe in a plane generally perpendicular to flow within the pipe.

46. The method for measuring flow properties of the multiphase mixture including hydrocarbons flowing in the pipe of stratified flow as recited in claim 44, wherein the measuring step uses a plurality of transit-time ultrasonic elements to measure a gas phase and/or liquid phase velocity.

47. The method for measuring flow properties of the multiphase mixture including hydrocarbons flowing in the pipe of stratified flow as recited in claim 44, further comprising a step of determining a speed of sound within the liquid phase using the differential pressure.

48. The method for measuring flow properties of the multiphase mixture including hydrocarbons flowing in the pipe of stratified flow as recited in claim 44, wherein the measuring step uses a pulsed Doppler transducer.

49. The method for measuring flow properties of the multiphase mixture including hydrocarbons flowing in the pipe of stratified flow as recited in claim 44, wherein the measuring step uses a Doppler array comprised a plurality of pulsed Doppler transducers.

50. The method for measuring flow properties of the multiphase mixture including hydrocarbons flowing in the pipe of stratified flow as recited in claim 44, further comprising a step of swirling the multiphase mixture to stratify the liquid phase in an annulus arranged proximate to an inner wall of the pipe.

51. The method for measuring flow properties of the multiphase mixture including hydrocarbons flowing in the pipe of stratified flow as recited in claim 44, wherein the pipe is arranged horizontally to stratify the multiphase mixture.

52. The method for measuring flow properties of the multiphase mixture including hydrocarbons flowing in the pipe of stratified flow as recited in claim 44, wherein the pipe is arranged horizontally to stratify the multiphase mixture.

53. The method for measuring flow properties of the multiphase mixture including hydrocarbons flowing in the pipe of stratified flow as recited in claim 44, wherein:
the measuring step uses a pulsed Doppler transducer, and
the pulsed Doppler transducer operatively engages a lower half of the pipe below a horizontal plane aligned with the middle line of the pipe.

54. The method for measuring flow properties of the multiphase mixture including hydrocarbons flowing in the pipe of stratified flow as recited in claim 44, further comprising a step of automatically determining a diameter of an interior of the pipe.

55. A method for measuring flow properties of a multiphase mixture flowing in a pipe of stratified flow, the method comprising steps of:
stratifying the multiphase mixture flowing in the pipe;
providing a diameter of an interior of the pipe;
sampling a differential pressure between two points of the pipe wherein:
the two points include a first point and a second point, and
the first point is generally opposite from the second point and generally arranged along a circumference of the pipe;
determining a height of a gas-liquid interface within the pipe using the differential pressure;
measuring a gas velocity and/or a liquid velocity of the stratified flow without intruding into the stratified flow using a pulsed Doppler transducer, which operatively engages a lower half of the pipe below a horizontal plane aligned with the middle line of the pipe; and
calculating liquid flow within the pipe using the gas velocity and/or the liquid velocity and the height.
